(19) United States
(12) Patent Application Publication
(10) Pub. No.: US 2004/0133497 A1
(43) Pub. Date: Jul. 8, 2004

(54) System and methods for determining performance-weighted consensus

(76) Inventor: Gregory R. Spear, West Hartford, CT (US)

Correspondence Address: Joan T. Kluger, Schnader Harrison Segal & Lewis LLP, IP Department, 1600 Market Street, Suite 3600, Philadelphia, PA, 19103, US

(21) Appl. No.: 10/742,200

(22) Filed: Dec. 18, 2003

Related U.S. Application Data
(60) Provisional application No. 60/434,254, filed on Dec. 18, 2002.

(51) Int. Cl. G06F 17/60

(52) U.S. Cl. 705/36; 705/35

(57) ABSTRACT

Systems that rank investment recommendations according to the relative historical performance of the sources of the recommendations are provided. In certain embodiments, the present invention provides systems that rank investment vehicles according to relative likely future performance, derived from the average relative historical performance of the advisory services or systems that currently recommend those vehicles. The present invention relates primarily to systems using automated computation, i.e., computer systems and software, but is not limited to such systems.

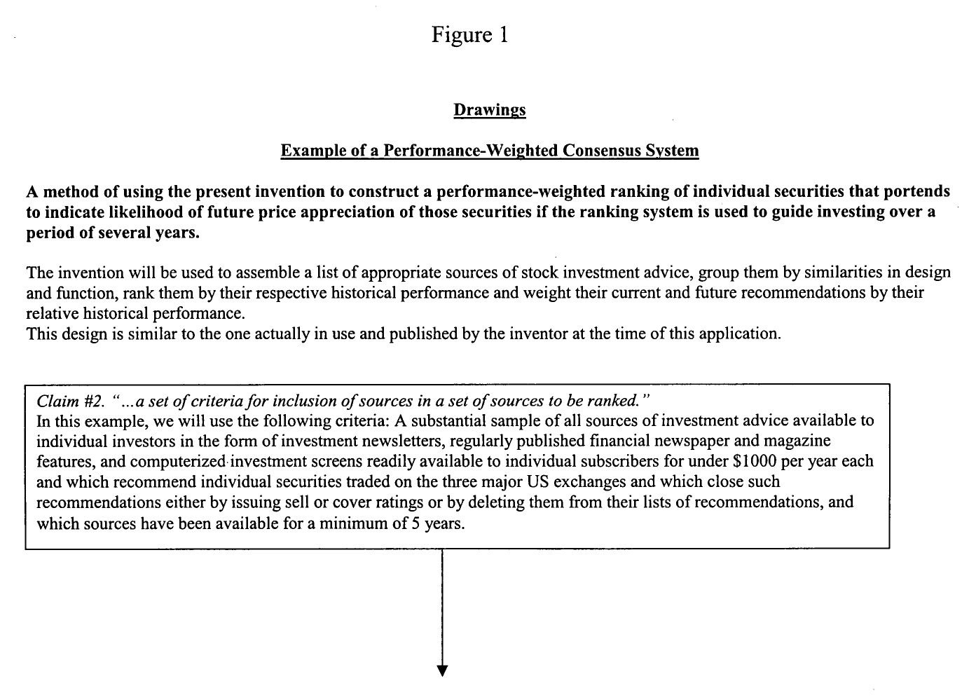

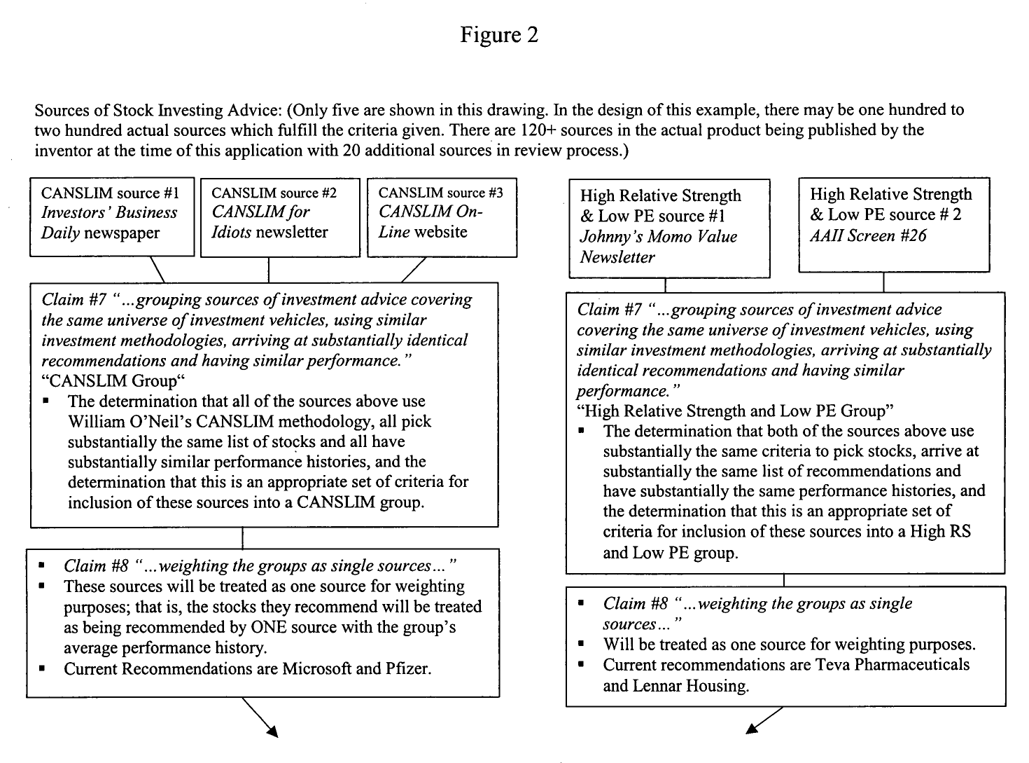

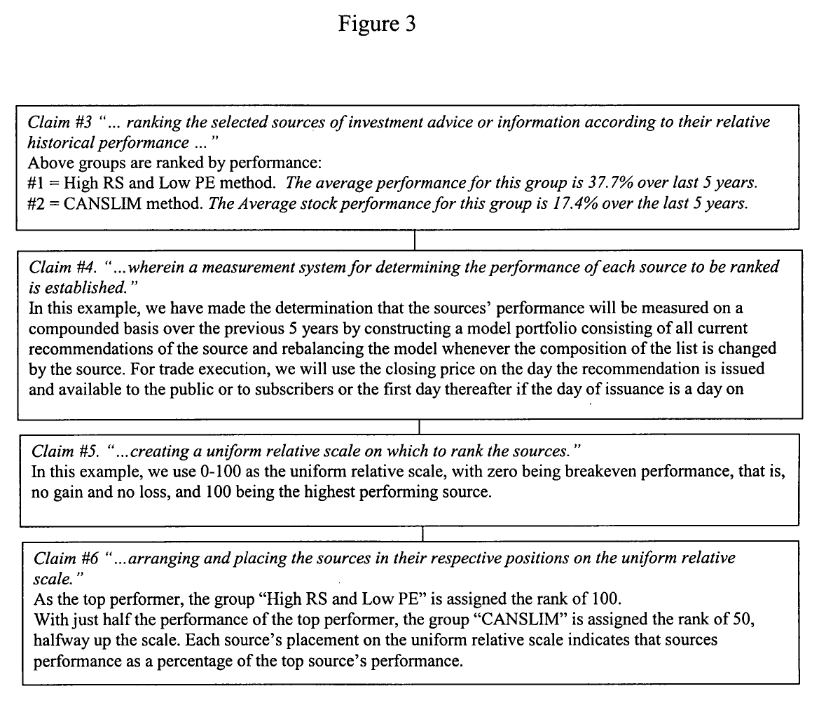

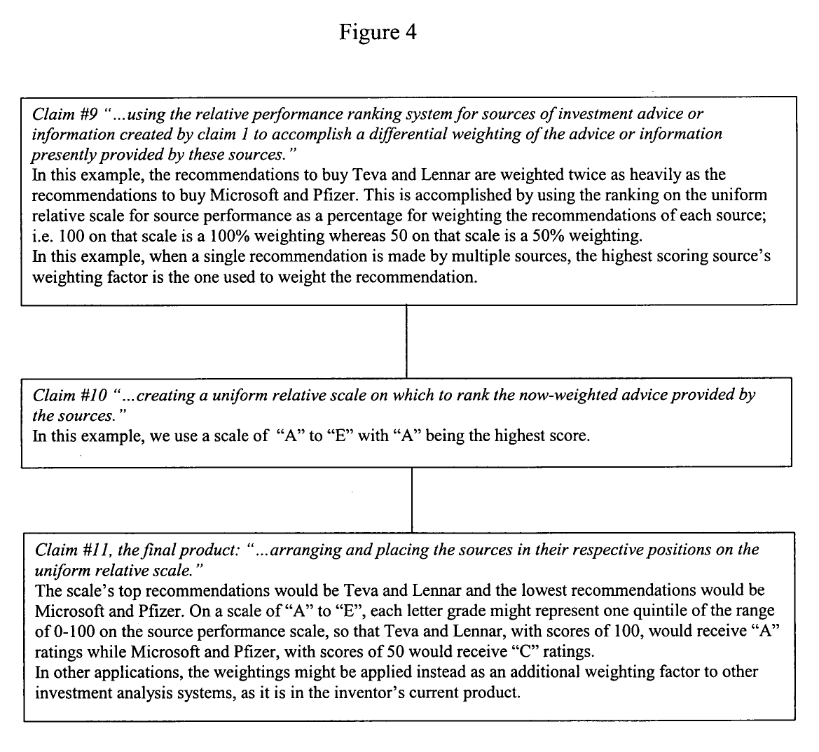

### FIELD OF THE INVENTION

The present invention relates to systems and methods for performing computational analysis. More specifically, a system is disclosed that ranks investment recommendations according to the relative historical performance of the sources of the recommendations. A system that ranks investment vehicles according to relative likely future performance derived from the average relative historical performance of the advisory services that currently recommend those vehicles.

### BACKGROUND OF THE INVENTION

There are numerous academic articles that discuss how the historical performance of a given indicator may be used to help predict future performance of equity markets. There also exists a body of literature describing how the historical performance of an advisor may be used with some caution to indicate the advisor's future performance. The current invention crosses these genres to predict equity performance by using the historical performance of the indicators or advisors who are currently recommending a given equity to differentially weight the current advice of the indicators or advisors to produce a more predictive composite, or consensus, of advice on a given equity.

As used hereafter the term “Advisors” means any persons, systems or other entities offering advice, analysis, opinions or information for the purpose of predicting an outcome or the probability of an outcome in the field of investments.

Examples of professionals who may offer such advice and may then be classified as “Advisors”: financial advisors, financial analysts, certified public accountants, certified financial planners, registered investment advisors, hedge-fund managers, mutual fund managers, private portfolio managers, wealth managers, newsletter writers, television commentators, newspaper or magazine columnists, financial experts, financial software engineers, financial marketing professionals.

Examples of systems which may offer such advice and may then be classified as “Advisors”: mechanical or computational indicators of equity market performance, financial software programs, technical analysis or “charting” programs and their embedded indicators, financial expert systems.

As used herein, the term “Advice” means advice, analysis, opinions or information provided by Advisors

There are thousands of publicly or privately accessible sources of Advice concerning a wide range of investment vehicles found in the financial services and financial information industries. The Advisors providing this Advice operate in many specialized areas or types of investments, such as publicly traded equities, corporate bonds, government bonds, other fixed income products, real estate and real estate investment trusts, mutual funds, indexes, commodities, options and other derivatives.

Within each of these areas, Advisors offer analyses with the purpose of predicting or aiding in the prediction of likely return from each of these vehicles over varying periods of time and various anticipated conditions. Others offer Advice on allocation of portfolio assets among some or all of these specialized investment arenas. Still others offer “wealth management” advice that extends to the design and/or effective utilization of various tax shelters and other estate management issues.

There also exist several systems whose purpose is to aggregate the advice of these Advisors. Some examples include organizations offering computed aggregations of analyst estimates of future corporate earnings of companies offering publicly traded stock. This “consensus of earnings estimates” is widely available and referenced often by the financial media. Another example is vendors of aggregated buy/sell/hold advice from large institutions regarding the publicly traded stock of companies. This “consensus recommendation” information is also widely available and widely referenced by the financial media. Another example is vendors who monitor the performance of private asset managers, such as hedge-fund managers and private portfolio managers. Yet another example is vendors who monitor publicly offered advice available freely through the major financial media or via niche subscription services such as web-sites or newsletters.

The current invention is a new method of constructing a consensus of Advice being offered by a given set of Advisors, which differentially weights the current Advice of each Advisor in the consensus according to the historical performance of the Advisor. The resulting performance-weighted consensus has a significantly higher likelihood of successfully predicting the performance of a given equity than these existing systems.

### GENERAL EXAMPLE #1

The improvement in usefulness to the end-user will be apparent in the following example.

Let's say that a certain mid-capitalization stock, followed by four Wall Street analysts, is currently rated a consensus “Buy” by a certain existing vendor of consensus Advice, because it is recommended as a “Buy” by all four of the analysts currently covering this security for the banking industry. The implication to the end-user, or investor, is obvious. The stock is highly rated and probably a good investment.

In certain preferred embodiments of the present invention, however, it may be determined that all of these analysts have performance records indicating that following their advice in the past has, on average, for both the short-term and the long-term, resulted in a negative Return-On-Investment. The present invention would therefore issue a strongly negative rating for this security, reflecting the known relative performance of the recommending sources.

### GENERAL EXAMPLE #2

Another example would be the popular “consensus of earnings estimates” offered by the same organizations noted above. These existing methodologies gather analyst estimates of future company earnings and amalgamate these estimates into a single “consensus” estimate for each security's future earnings for a given period.

Once again, only a simple arithmetic average of estimates is used to compose these consensus figures in all cases.

If, instead, the relative performance of the analysts is used to differentially weight the estimates that compose the final consensus estimate, a much higher level of accuracy can be expected.

The improvement offered by the present invention is therefore a quantum leap over other existing consensus methodologies.

### SUMMARY OF THE INVENTION

The invention is an improvement over arithmetic averaging of recommendations because the purpose of any consensus-reporting system is to attempt to predict future performance of investment vehicles, and the proven past performance of each source of advice on said vehicles is a critical component in this effort to predict future performance of the vehicles. The current invention is a method whereby the past performance of each Advisor in a set of Advisors is used to differentially weight each Advisor's current Advice to create a performance-weighted consensus of Advice to more accurately predict the future movement of the object of the Advice.

### DETAILED DESCRIPTION OF THE PREFERRED EMBODIMENTS

The invention begins with a computer database designed to track a set of any selected group of Advisors providing Advice on the same type or universe of investment vehicles, such as stocks, mutual funds, commodities, bonds, real estate, etc.

The computer database enables storage of the historical recommendations of each Advisor, including but not limited to the following data fields:

Advisor identification:

Publication/Website/Software Program or Investment Bank/Brokerage, etc. which has published the recommendation

Column, Feature or Department in which the recommendation appears

Most discrete Portfolio or List on which the recommendation appears

Reporter or columnist who selected this Analyst or List to include in this issue

Individual Analyst making the recommendation

In the case of the Advisor being a system, the methodology or indicator being used to generate the Advice

Type of investment vehicle being recommended

Specific investment vehicle being recommended

Date and time recommendation became accessible to the public or to the subscribers or users of the Advisor's service, if a public service, or date and time the Advisor generated the recommendation in the case of a non-public service or system

Type of Trade (common stock, option, etc.)

Recommendation (buy, sell, hold, strong buy, strong sell, etc.)

Trigger price, if any

Limit price, if any

Stop price, if any

Price target, if any

Purchase Price (cost basis)

Closing Price (proceeds)

Date and time trade was closed

Identification of the Operator who recorded all of the above information

The invention then preferably uses a computer software program to compute the relative performance over time of each of the Advisors in a given set, using industry standard measures such as annualized return on investment (ROI), average weighted or unweighted return from all investments, volatility of both the investments and of the portfolio as a whole either absolutely or in relation to an appropriate market index, and/or any of a number of other standard measures available to the user through the program's interface. The particular measures used are selectable by the user to accommodate the different sets of Advisors and objectives of the user. The program supplies a matrix of recommended settings for specific purposes.

### EXAMPLE OF THE USE OF VARIOUS CRITERIA OR SETTINGS TO MEASURE ADVISOR'S HISTORICAL PERFORMANCE

To find Advisors whose recommendations are likely to outperform if held for 1-3 months in a bull market period, use the following settings:

Set of Advisors: Common Stock

Comparison Index: NASDAQ

Market Direction: Any date on which the most recent week's ending price of the Comparison Index is higher than that of the week ending 6 Months prior

Period to Measure Advisors: 5 Calendar Years

(Will measure Advisor performance only during periods defined by Market Direction above, which occur during this calendar period.)

Holding Period in Months from Recommendation: 2

Sells: Ignore

Minimum total qualifying recommendations: 6

Return Advisors whose Performance in Relation to Other Advisors is:

Unweighted Return=Top 25%,

Beta=Top 25%,

Relative Strength vs. NASDAQ=Top 20%

Preferred embodiments of the present invention use a composite of these measures of performance to create a Uniform Relative Scale in order to rank the Advisors in each set. The invention offers several pre-set scales to suit specific purposes, and allows the end-user to customize their own scale within the limits of the available data concerning the historical performance of the Advice of the Advisors. The purpose of the scale is to aid in the prediction of future performance of various investment vehicles through the invention's performance-weighted data reporting system.

General criteria for all Uniform Relative Scales include the following:

a) A reasonable and demonstrable expectation of reliability in accurately describing the relative past performance of the set of Advisors providing financial Advice in a given specialty.

b) A reasonable belief that the Scale reflects factors that have a significant relationship to the predictive value of the Advice.

### EXAMPLES OF UNIFORM RELATIVE SCALES

In the set of Advisors offering advice whose purpose is to predict stock price movement, a number of different Uniform Relative Scales may be utilized by the invention depending on the nature of the data set and the objectives of the user:

(i) Long-term (user-selectable period) historical performance of the source set, either absolute or relative to various indexes,

(ii) Intermediate-term (user-selectable period) historical performance of the source set either absolute or relative to various indexes,

(iii) Short-term (user-selectable period) historical performance of the source set, either absolute or relative to various indexes,

(iv) Bull market (user-selectable periods) historical performance of the source set, either absolute or relative to various indexes.

(v) Bear market (user-selectable periods) performance, either absolute or relative to various indexes.

(vi) Up-Beta/Down-Beta: the measurement of historical performance relative to various indexes (user selectable indexes) and performed in such a manner as to show the relative performance of the Advice in rising market periods as distinct from the relative performance of the Advice in declining market periods.

(vii) Various other common measures of momentum, risk, volatility, etc. of the Advice offered in the past, either absolute or relative to various user selectable indexes.

(viii) Various combinations of the factors used in the other scales, the factors being differentially weighted to reflect the relative importance of each one to the task of predicting future performance for a given time period or a given set of market conditions, in the opinion of the user of the invention.

Normalization of the Scale

The raw performance scores of each Advisor on a given Uniform Relative Scale are then distributed proportionately on a scale of −99 to +99.

Current Advice Collection

Having assigned a rank to each Advisor using the above methods, each Advisor is monitored on-going to determine their current Advice, which is catalogued and stored in the same computer database described above. This current Advice becomes part of the historical performance record for the Advisor and will influence their rank in future periodic computations.

Identification of Recommendations

Having stored in the database all the recommendations for a given time period of all the Advisors of a given type, the invention then preferably determines for each investment vehicle the set of Advisors which are providing current advice on that vehicle.

Constructing Performance Weighted Rank on a Given Investment Vehicle

For each investment vehicle, the invention then preferably averages the rank of each Advisor making a current recommendation on that vehicle; to arrive at a performance weighted rank number for the vehicle itself. Because the Advisors are all assigned performance rank numbers on a normalized scale of −99 to +99, the final averaged score for each investment vehicle must necessarily also fall in this same range. This relative ranking of investment vehicles according to the performance of the Advisors providing the recommendations is the final product of the invention.

In some cases, as illustrated below in Example #2, rather than a final recommendation on an actual investment vehicle, the data relates only to one factor out of many that are used to construct such a recommendation. Earnings estimates are the example used below to illustrate this usage of the invention, since earnings estimates factor into many systems of assessing the value of a company's stock, but don't normally constitute a recommendation in themselves. In this case, the Performance Weighted Rank system offered by the invention is used to construct a performance weighted consensus estimate, rather than the final stock recommendation.

### Example 1 of General Use of the Invention

Generating a List of Performance Weighted Recommendations of Common Stocks Likely to Outperform in a Bear Market:

1. All Advisor Recommendations on Common Stocks

Financial television programs, stock newsletters, money managers etc. all recommend certain common stocks. All of this data is gathered in a central database of current and past recommendations.

2. Calculating Performance

The average performance of all the recommendations made by each Advisor in all periods defined as Bear Market, such as periods in which the S&P 500 has declined on a trailing 6-month basis, is calculated by software.

3. Uniform Relative Performance Scale

a) The invention then preferably ranks the analysts using a uniform relative scale for Advisor performance in a Bear Market, by looking only at each Analyst's recommendations made during down market periods for which the database has data.

b) The raw performance scores for the Analysts are then normalized, that is, they are distributed proportionately along a −99 to +99 scale with “0” equal to market performance.

4. Current Advice

a) The software then determines the current stock recommendations of all the Advisors in this set.

5. The invention then preferably identifies which Advisors recommend any given stock.

6. Construction of Performance Weighted Rank

Each analyst's position on the Uniform Relative Scale indicates the relative weight to be given to his or her current estimates in the invention's arrival at a final performance weighted rank for each recommendation made by each Advisor:

a) e.g. for stock of Microsoft (MSFT):

| Advisors Currently | Rank on Bear Mkt |
|---|---|
| Recommending MSFT | Performance Scale. |
| Navellier | 50 |
| J. Collins | 25 |
| G. Gilder | 75 |
| AVERAGE | 50 |

MSFT rank on Bear Market Performance Scale =50

7. Generating a list of performance-weighted recommendations for a bear market:

The software then similarly ranks all securities recommended by all qualifying analysts and sorts the securities by rank. The top ranked securities are those most likely to outperform the market if the market exhibits a bear market performance immediately ahead.

### Example 2 of General Use of the Invention

In the field of estimating earnings for companies with publicly traded stock, the invention performs as follows:

1. Analyst Estimates of Corporate Earnings

Several vendors offer access to earnings estimates provided by Wall Street analysts. This is the initial data set with which the invention works. Sub-groups may be established using the sector or industry being covered by the analysts. The earnings estimates offered by these analysts are collected and recorded in the database by the operators of the invention, and/or the operators of the invention may utilize earnings estimates collected and recorded by third-parties.

2. Calculating Performance

The difference between the earnings estimates provided by each analyst and the subsequently reported actual earnings of the companies is then calculated and used as a basis for measuring the relative accuracy (performance) of each analyst in estimating corporate earnings.

3. Uniform Relative Performance Scale

a) The invention then preferably ranks the analysts using a uniform relative scale for each sub group so that analysts may fairly be compared to each other within a group and between groups. Examples of groups may be:

(i) Analysts covering companies in the steel industry

(ii) Analysts covering companies in the bio-technology industry.

(iii) Analysts covering companies in the long-term care industry

(iv) Analysts covering companies in the restaurant industry

b) For each group, the raw performance scores are normalized, that is, they are distributed proportionately along a −99 to +99 scale.

c) For instance, Analyst “A” covering the steel industry is given a score of “0” indicating that his/her performance in the past is half-way between the top performer and the bottom performer of the analysts covering steel. Analyst “B” is also given a score of “0” indicating that his/her performance in the past has been about half-way between the top performing and bottom performing analysts covering bio-technology. In this manner, Analysts “A” and “B” may be fairly compared to each other as being equal in performance, despite the very different industries they cover, and despite the fact that Analyst “A” in steel had a much better record of accurately predicting earnings than Analyst “B” in bio-technology, because the larger set of variables in the newer, more experimental, and more regulated industry of bio-technology makes it more difficult to accurately predict earnings in that industry. The use of the invention's Uniform Relative Scale compensates for such differences between the groups so that earnings estimated by analyst “A” would receive the same relative accuracy rating as those recommended by Analyst “B.”

4. Several different Uniform Relative Scales are offered by the invention to accomplish the above, such as the following:

a) Accuracy in estimating net earnings for the coming Quarter

b) Accuracy in estimating net earnings for the coming Year

c) Accuracy in estimating net earnings for the coming 5 Years.

d) A scale that incorporates each of the above, and weights them differentially to emphasize one over the other depending on the historical relationship shown between each of them and the movement of stock prices subsequent to the announcement of such estimates

5. These scales meet the Criteria established in the present Description of the invention for the construction of a Uniform Relative Scale as follows:

a) Estimates of net earnings by Wall Street analysts and actual net earnings for most companies are widely available, providing for easy comparison and therefore the assurance of “reasonable and demonstrable reliability in accurately describing the relative performance of the Advisors.”

b) The assumption that past performance in estimating company earnings within a given industry may be predictive of future performance in the same constitutes “a reasonable belief that the Scale reflects factors that have a significant relationship to the predictive value of the Advice.”

6. Current Advice Collection

a) The analysts are then monitored on-going to determine the current estimates being provided for each covered company by each analyst.

7. The invention then preferably identifies which analysts cover any given company.

8. Construction of Performance Weighted Rank

Each analyst's position on the Uniform Relative Scale indicates the relative weight to be given to his or her current estimates in the invention's arrival at a final performance weighted consensus estimate for that company, as shown below:

| | Rank on Q1 | EPS Estimate |
|---|---|---|
| a) Analyst | Performance Scale | Q1 for MSFT |
| G. Smith | 50 | 1.22 |
| A. Lincoln | 25 | 1.13 |
| U. Grant | 75 | 1.28 |

Constructing a Weighted Average

1.22×50

1.13×25

1.28×75

Total*150=1.24

Performance-Weighted Consensus Estimate for Q1 for MSFT=$1.24.

### Detailed Discussion of Existing Consensus Products and the Improvement Offered by the Current Invention

All of the current systems of aggregating information from various financial Advisors use one of three broad methodologies, alone or in some combination.

The first methodology is a simple arithmetic computation that serves to average the advice of available and participating Advisors, usually Wall Street banks and brokerages involved in investment underwriting. Examples would be “averaging” the estimates of, for example, nine analysts, to obtain a “consensus” estimate for the earnings of a particular stock, e.g., Microsoft (Nasdaq: MSFT).

Examples of the first methodology are found in the products of First Call, IBES and Zacks, which all offer reports for many publicly traded stocks consisting of a consensus of earnings estimates and a consensus of buy-sell-hold recommendations from a variety of analysts employed by brokerages, banks and stock underwriting firms.

This methodology might produce a statement such as “Microsoft is a Strong Buy, with nine analysts contributing” or “The consensus earnings estimate for Microsoft for this year is $2.30.”

A second methodology selects Advisors to monitor according to a measure of their performance, for example; newsletter writers who have beaten the market in the last five years, and then uses the arithmetic averaging system to aggregate their advice, producing a statement such as “Of all monitored newsletters which have beaten the market in the last five years, the most popular recommendations are Microsoft (Nasdaq: MSFT) and General Electric (NYSE: GE).

Two current examples of this methodology:

(i) The Spear Report

The inventor of the current invention has published a consensus stock recommendation product since November of 1995 known as The Spear Report. This publication provides selected stock recommendation sources with recognized above-market performance and publishes a list of securities that is recommended by at least two of these sources. In this product, there is no differential weighting given to the sources reflecting the differential performance of the sources. All recommendations are weighted equally, irrespective of the differences in performance that may have existed between the recommending sources. There is also no consideration given to sources which might recommend the same securities but which had poor relative performance or even negative return. These sources are ignored by this existing system and are an important factor in the invention.

(ii) The Hulbert Financial Digest

In a regular column of this publication, a consensus list is provided of all stocks recommended by at least two of the financial newsletters monitors by the publication which have market-beating performance for a given period, such as the last 5 years. While this is a consensus of a group of sources selected for their common performance characteristics, it is not a performance-weighted invention in that it cannot account for relative performance among this group nor can it take into consideration recommendations on those same securities that are made by sources that have lesser performance, and especially, negative performance. There is no differential weighting of performance at all in this product. There is selection by performance, but no differential weighting, the essence of the present invention.

The effective improvement offered by the present invention over the methodology employed by The Hulbert Financial Digest is similar to the improvement offered over other consensus products. For example, Hulbert reports the fact that two five-year market-beating sources have recommended a certain security. His methodology stops there. Hulbert's methodology implies that the security has an above-average chance of appreciation.

However, in accordance with preferred embodiments of the present invention, two additional factors are considered by the present invention; namely: the relative performance of sources within this group, and other recommendations of the same security currently being offered by other sources, including sources with negative performance. In such embodiments the present invention goes much further than Hulbert's product, to weight each recommendation according to the past performance of the source, including providing negative weightings to recommendations from under-performing sources.

For example, Hulbert's publication issues a de-facto recommendation by naming a security that is recommended by at least two sources with 5-year out-performance records. The present invention, however, also takes into consideration that the same security may be recommended by several newsletters with “kiss-of-death” 5-year performance records, such as −15% and −33% per year, and perhaps others with shorter or longer performance records that might be equally dismal. These other sources issuing recommendations on the same security cannot be considered by Hulbert's methodology by definition, because they are not “5-year market beaters,” but in accordance with preferred embodiments of the present invention they would partially offset or perhaps even reverse the implied recommendation offered by Hulbert's methodology, with obvious implications for the expected performance of the security being recommended.

While Hulbert's methodology considers only the recommendations made by sources that beat the market for a certain time-period, and treats all such sources the same, certain embodiments of the present invention disclosed herein are capable of considering all recommendations by all available sources and weighting each one differentially depending on the past performance of that source. This makes the present invention qualitatively and fundamentally different from, and superior to, Hulbert's methodology.

Other methodologies do report on source performance data, but make no effort to rank the securities recommended by the performance of the source:

e.g. CNBC.com tracks the performance of stocks recommended by all guests appearing on the CNBC financial television program. CNBC.com then shows both the performance of the stocks, and shows the performance of each guest, but does not rank the guests, nor does it posses a system whereby it could use the relative performance of the guests to rank the recommended stocks.

A third methodology selects Advisors to monitor as a product of a commercial transaction wherein the Advisors compensate the aggregator in exchange for inclusion in the aggregator's system, and then the aggregator either uses an arithmetic averaging system to aggregate the data provided by the sources or it uses various marketing criteria such as which source-title is selling best at the moment. Examples include various operators of “newsletter stores” which aggregate the advice of certain newsletters offered for sale in the store, and whose publishers are willing to share revenue with the store's operator. Investools.com and Zacks.com are examples of organizations operating financial newsletter stores that may occasionally aggregate advice in this manner.

None of these, or any other current examples of consensus tools existing today, currently do anything other than arithmetically average the various estimates and recommendations. None of the existing consensus products can differentially weight the earnings estimates or buy-sell-hold recommendations of the sources depending on the relative performance of each source in order to predict earnings or equity performance. This is the innovation offered in the present invention, and it is a significant departure from and improvement upon the common method of offering a simple arithmetic average of recommendations.

As with other investment analysis systems, this invention may be used alone or in combination with any number of other systems. In the inventor's present application of the invention, it is used as an additional weighting factor to the factor of number of recommendations that each security has received.

Upon review of the foregoing, numerous adaptations, modifications, and alterations will occur to the reviewer. These will all be, however, within the spirit of the invention. Accordingly, reference should be made to the appended claims in order to ascertain the true scope of the present invention.

What is claimed is:

1. A method for using a computing device or other analytical means to differentiate and rank sources of financial advice or other financial information intended to assist in predicting certain factors thought to influence the likelihood of accomplishing successful investment decisions, said ranking to be based upon the relative past performance of the sources in assisting said predictions.

2. The method of claim 1 wherein a set of criteria is established for inclusion of sources in a set of sources to be ranked.

3. The method of claim 1, further comprising the step of ranking the selected sources of investment advice or information according to their relative historical performance in producing investment return or in producing accurate predictions of the object of the advice if other than investment return.

4. The method of claim 3 wherein a measurement system for determining the performance of each source to be ranked is established.

5. The method of claim 3 further comprising the step of creating a uniform relative scale on which to rank the sources.

6. The method of claim 3 further comprising a method of arranging and placing the sources in their respective positions on the uniform relative scale.

7. The method of claim 1, further comprising the grouping of sources concerned with the same universe of investment vehicles, using similar analytical or assessment methodologies, arriving at substantially identical recommendations and having similar records of performance.

8. The method of claim 1, further comprising the step of weighting the groups as single sources for the purpose of weighting and ranking the groups' recommendations.

9. The method of using the relative performance ranking system for sources of investment advice or information created by claim 1 to accomplish a differential weighting of the advice or information presently provided by these sources.

10. The method of claim 9, comprising the step of creating a uniform relative scale on which to rank the now-weighted advice provided by the sources.

11. The method of claim 9 further comprising a method of arranging and placing the sources in their respective positions on the uniform relative scale.
